(19) United States
(12) Patent Application Publication
(10) Pub. No.: US 2006/0176368 A1
(43) Pub. Date: Aug. 10, 2006

(54) Visual watching device for an automobile for detecting the dead angle caused by a front post

(76) Inventors: Wen-Cheng Yang, Yilan City (TW); Hsiao-Yen Chou, Taipei-City (TW)

Correspondence Address: TROXELL LAW OFFICE PLLC, SUITE 1404, 5205 LEESBURG PIKE, FALLS CHURCH, VA, 22041, US

(21) Appl. No.: 11/050,841

(22) Filed: Feb. 7, 2005

(51) Int. Cl. H04N 7/18

(52) U.S. Cl. 348/142; 348/148

(57) ABSTRACT

A visual watching device for an automobile for detecting the dead angle caused by the front posts and the rear posts includes a camera respectively deposited on the front posts and the rear posts, and a thin display respectively on the front and the rear posts, and a power source supplying the cameras and the displays with electricity. Then the images taken in by the cameras are transmitted to the displays so the driver can directly look at the images showing the traffic condition of the dead angles hidden by the front and the rear posts for taking proper prompt measures for keep safe the automobile and persons on it.

### BACKGROUND OF THE INVENTION

1. Field of the Invention

This invention relates to a visual watching device for an automobile, particularly to one for detecting the dead angle caused by a front post and a rear post of an automobile in order to keep the automobile safe in running.

2. Description of the Prior Art

Nowadays automobiles are indispensable tools in our daily life, and their accessories are quite a lot, especially for keeping them safe in running, for example, various radar or visual systems for backing cars. And the radar or visual systems generally includes a sensor fixed on the rear bumper for detecting the traffic condition behind the car for helping a driver to watch the road condition hidden by the dead angle impossible to be seen by the rearview mirror.

However, in using the rearview mirror, the front posts at the two sides are an obstacle for viewing functioning as a dead angle for a driver, making up a potential risk in running of an automobile. So a driver may lose the proper opportunity for stepping on the brake in time. Moreover, the dead angle by the rear post always becomes a great trouble for backing an automobile. Those dead angle caused by the front and the rear posts is almost impossible to be get rid of by means of conventional radar or observing system and only compensated by alarming sound.

### SUMMARY OF THE INVENTION

This invention has been devised to offer a visual watching device for an automobile for detecting the dead angle caused by the front posts and the rear posts of an automobile. The device includes a camera respectively installed on the front and the rear posts and facing the exterior of the automobile, a thin display respectively fixed in the front and the rear posts, connected with the cameras electrically and facing the driver, and a power source supplying the cameras and the displays with electricity. Then the traffic conditions hidden by the front and the rear posts can be picked up by the cameras and shown on the displays for the driver to watch for taking necessary measures, to avoid accidents and keep safe his/her automobile and persons on it in addition to passersby and other automobiles.

### BRIEF DESCRIPTION OF DRAWINGS

This invention will be better understood by referring to the accompanying drawings, wherein:

FIG. 1 is an upper view of the locations of a visual watching system fixed on an automobile in the present invention;

FIG. 2 is a partial side view of the visual watching system fixed on an automobile in the present invention;

FIG. 3 is an exploded perspective view of the visual watching system in the present invention; and,

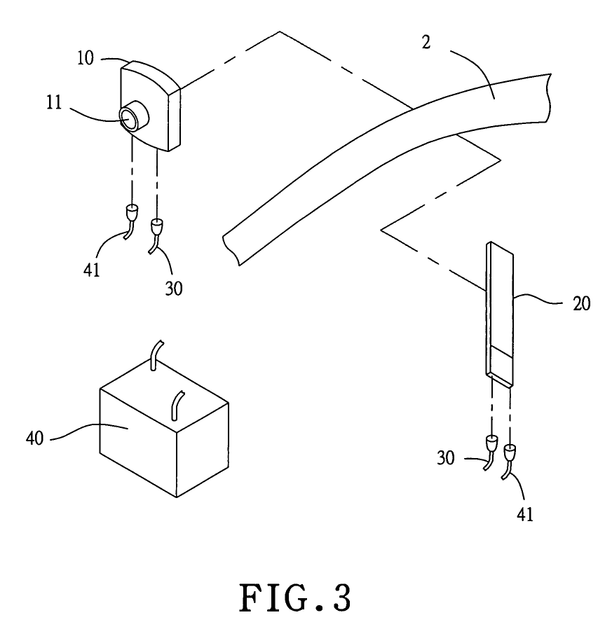

FIG. 4 is a view of the visual watching system being used in an automobile in the present invention.

### DETAILED DESCRIPTION OF THE PREFFERED EMBODIMENT

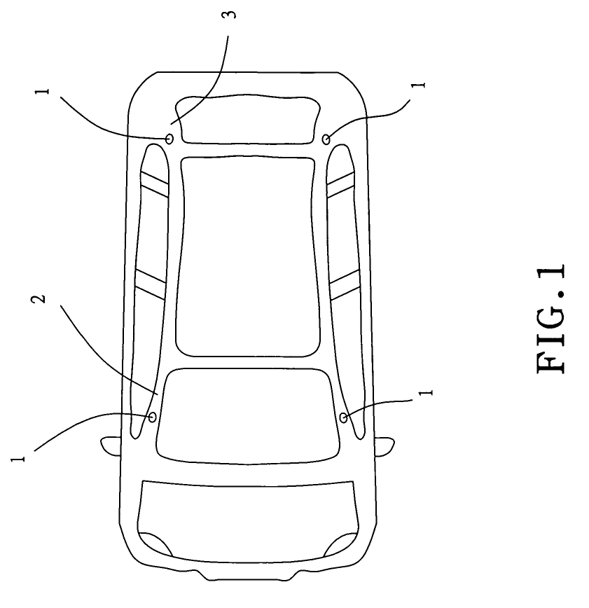

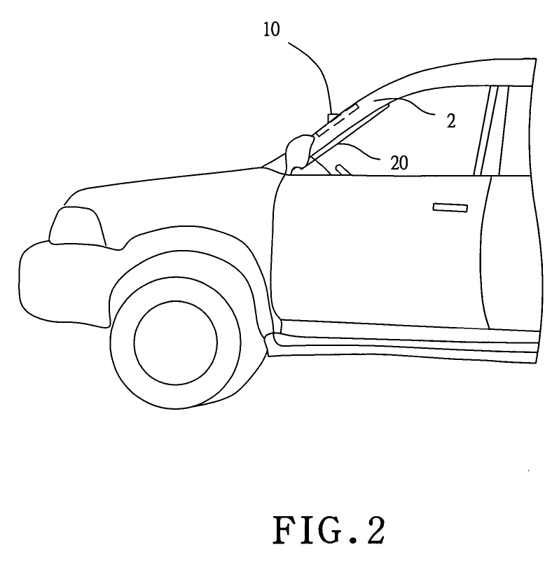

A preferred embodiment of a visual watching system 1 for an automobile for detecting the dead angle caused by the front post in the present invention, as shown in FIGS. 1 and 2, includes four cameras 10, four displays 20, four signal wires 30, and an electric power source 40.

The cameras 10 are respectively deposited on two front posts and two rear posts of an automobile, with its lens 11 facing the exterior of the automobile. Then a user adjusts the proper angles of the cameras 10 and multiple of the lens 11, letting the road condition and the scene around the road completely picked up by the lens 11 and transmitted to the displays for showing out.

The displays 20 are very thin, with its width being almost the same as that of the front and the rear posts 2 and 3, and with its length being almost the same as that of the front and the rear post 2 and 3. The displays 20 are respectively deposited in the front and the rear post 2 and 3 properly so that the driver can look at them just straightly on the front sides or indirectly through the rearview mirror.

The signal wires 30 are respectively connected between each camera 10 and each relative display 20, so the image seen through the lens 11 may be completely and clearly shown on the screen of the displays 20.

The power source 40 is arranged in an automobile properly, and it can be a battery of an automobile, connected with each camera 10 and each display 20 by means of power wires 41 for supplying electricity.

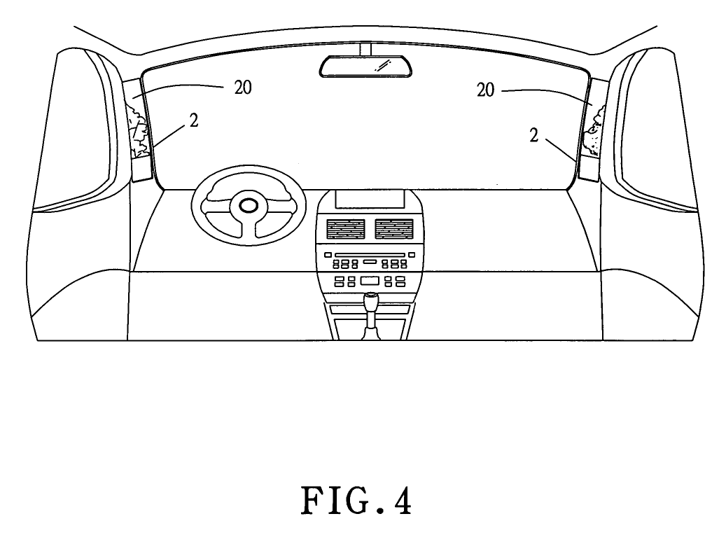

In using, a driver can directly look at the displays 20 on the front posts 2, for viewing the scene and the traffic condition on the road it runs on, and the scene is the dead angle that could otherwise not be seen, and the driver can easily see it on the displays 20, as shown in FIG. 4. Therefore, if any vehicles or passersby or possible obstacles appear on the displays 20, the driver can quickly takes proper measures to avoid it or pedal at once the brake in order to keep safe the automobile and persons on it. At the same time, the driver can also look at the rearview mirror for the scene appeared on the displays 20 on the rear posts 3, also taking care of the traffic condition behind his car, with the dead angle of the rear posts 3 gotten rid of. In this way a driver can control the safety of backing an automobile.

While the preferred embodiment of the invention has been described above, it will be recognized and understood that various modifications may be made therein and the appended claimed are intended to cover all such modifications that may fall within the spirit and scope of the invention.

What is claimed is:

1. A visual watching device for an automobile for detecting the dead angle caused by the font post, said device comprising:
At least one camera deposited on a front post and having its lens facing to the exterior of the automobile for taking in the scene of the dead angle hidden by the front post:
At least one display deposited in the front post provided with said camera and facing the driver to be seen straight by the driver:
At least a signal wire connected between said camera and said display so that the image seen through the lens of said camera may be shown on said display: and,
An electric power source fixed properly in the automobile, connected electrically with said camera and said display to supply them with electricity.

2. The visual watching device as claimed in claim 1, wherein said display is very thin and wide as said front post.

3. The visual watching device as claimed in claim 1, wherein said visual watching device comprises a camera respectively deposited on two front posts and two rear posts, and a display respectively deposited on the two front posts, and said cameras and said displays are connected with relative said cameras by means of signal wires.

4. The visual watching device as claimed in claim 1, wherein said electric power source is a battery.

5. The visual watching device as claimed in claim 1, wherein said lens of said cameras is possible to be adjusted in the angle of view, and the multiple.
